(19) United States
(12) Patent Application Publication
(10) Pub. No.: US 2026/0175475 A1
(43) Pub. Date: Jun. 25, 2026

(54) PARTICLE FOAM MOLDING WITH DIFFERENT LAYERS

(71) Applicant: BASF SE, Ludwigshafen Am Rhein (DE)

(72) Inventors: Florian Tobias RAPP, Ludwigshafen am Rhein (DE); Cornelia CHELLA, Ludwigshafen am Rhein (DE); Petra SCHERRER, Ludwigshafen am Rhein (DE); Marcus GOEBEL, Ludwigshafen am Rhein (DE); Elmar POESELT, Lemfoerde (DE); Ines DEBEAUVAIS DE VASCONCELOS, Ludwigshafen am Rhein (DE)

(73) Assignee: BASF SE, Ludwigshafen Am Rhein (DE)

(21) Appl. No.: 19/124,959

(22) PCT Filed: Oct. 24, 2023
(86) PCT No.: PCT/EP2023/079602

§ 371 Date: Apr. 28, 2025

(30) Foreign Application Priority Data
Oct. 28, 2022 (EP) 22204531.2

(51) Int. Cl. B29C 44/34; B29C 44/44; B32B 27/06; C08J 9/00; C08J 9/18

(52) U.S. Cl. CPC B29C 44/3415; B29C 44/445; B32B 27/065; C08J 9/0061; C08J 9/18; C08J 2201/03; C08J 2203/14

(57) ABSTRACT

The present invention is directed to a Particle foam molding comprising a core-layer A and a cover layer B, both layers comprising expanded thermoplastic polyurethane beads, wherein the thermoplastic polyurethane is obtainable or obtained by reacting at least a polyisocyanate composition (IC) comprising at least one aliphatic diisocyanate and a polyol composition (PC) and, wherein the ratio of the average cell size of the cover-layer B to the average cell size of the core-layer A is in the range from 1:2 to 1:20. The invention is further directed to a method for the manufacturing of the particle foam molding and its use.

### BACKGROUND OF THE INVENTION

The present invention relates to a particle foam molding comprising a core-layer A and a cover layer B, both layers comprising expanded thermoplastic polyurethane beads with thermoplastic polyurethane based on an aliphatic diisocyanate and polyol composition and different average cell size and a method for the manufacturing of the particle foam molding.

Foam moldings comprising expanded thermoplastic polyurethane are widely used for sports apparel, shoes, and shoe parts as well as for cushioning elements. Such foam moldings also referred to as molded body, a preparation for a molded body, a process for manufacturing a molded body and the use of the molded body are described for example in WO 2022161994 A1. The part density plays a key role for this kind of application. Therefore, many efforts have been made to reduce the molding-density. Relevant approaches are described for example in DE102013110242 A1, WO 2017/125410 A1 and EP1690662 A1. US20220033609 A1 is directed to foamed pellets based on polymers which have sufficient stiffness while at the same time having good mechanical properties and good processability.

The manufacturing of moldings with foam particles of thermoplastic polyurethane by means of steam chest molding is described for example in DE102013110242 A1. Here, different methods to fill the mold are explained all with the intention to have a fully filled cavity and avoid undesired bridge-formation between the foam particles. The counterpressure-filling method is applied together with a pressure-loading of the foam particles before the actual filling operation. Therefore, the foam particle material is exposed in pressure-loading tanks to an overpressure. During subsequent vapor deposition in the mold, this leads to a greater expansion of the foam particles, so that the final molding has a lower density. However, the foam particle material is to be exposed in pressure loading tanks to an overpressure over a period of 6 to 24 hours.

WO 2017/125410 A1 and US 2021206036 relates to a method for producing a particle foam part wherein foam particles are heated in a mold such that they weld together. This foam particles are made from polyurethane (PU), polylactate (PLA), polyethylene block amide (PEBA) or from polyethylene terephthalate (PET). The heat is guided by means of electromagnetic RF radiation to the foam particles. In case of large or thick particle foam parts it is described that they heat up more strongly in the middle than in the edge region. An increase of the energy input by the electromagnetic field leads to a complete melting of the foam particles in the central area of the particle foam part.

A further approach to reduce the density is disclosed in EP1690662 A1. This invention relates to a rotational molding process for producing a foam composite with a low-density and integrated core, and with a skin that is strongly adhered to the core. The mold is charged with plastic powder or minute particles first and, subsequently, polyolefin pellets to which a cross-linking agent and a foaming agent has been compounded are added. The mould is heated from outside while being rotated and, thus, inducing the formation of a skin, the cross-linking of the polyolefin, the adherence of the polyolefin to the skin and the decomposing of the foaming agent.

However, a density reduction of particle foam moldings is often accompanied with reduced mechanical properties, in particular the compression stress is decreased by a homogeneous density reduction. Moreover, the welding of the single foam beads in the mold-cavity is often insufficient in case of low-density moldings because if less material by weight is loaded the interfaces of the single foam beads get not fully into contact anymore. Consequently, in between the foam particles porosities arise which cause a further reduction of mechanical properties. Furthermore, the density reduction often results in an incomplete filling of the edges and a rough surface appearance of the molding. Both effects cause variations in the mechanical properties.

It was therefore an object of the present invention to provide a low-density particle foam molding with good and homogeneous mechanical properties, in particular high compression stress. A further object is to provide a process for manufacturing the particle foam molding with dimensionally accurate edges and smooth surfaces.

### SUMMARY OF THE INVENTION

The problem is solved by particle foam molding comprising a core-layer A and a cover layer B, both layers comprising expanded thermoplastic polyurethane beads, wherein the thermoplastic polyurethane is obtainable or obtained by reacting at least components (i) to (ii):
(i) a polyisocyanate composition (IC) comprising at least one aliphatic diisocyanate having a number-average molecular weight of less than 200 g/mol
(ii) a polyol composition (PC) and,
   wherein the ratio of the average cell size of the cover-layer B, determined by image analysis based on scanning electron microscopy of at least 100 cells of a cross-sectional area located in 1 mm distance from the outer molding-skin, to the average cell size of the core-layer A, determined by image analysis based on scanning electron microscopy of at least 100 cells of a cross-sectional area located in the center of the molding, is in the range from 1:2 to 1:20.

In a preferred embodiment the ratio of the average cell size of the cover-layer B, determined by image analysis based on scanning electron microscopy of at least 100 cells of a cross-sectional area located in 1 mm distance from the outer molding-skin, to the average cell size of the core-layer A, determined by image analysis based on scanning electron microscopy of at least 100 cells of a cross-sectional area located in the center of the molding, is in the range from 1:2 to 1:10.

In a preferred embodiment at least one aliphatic diisocyanate is a hexamethylene diisocyanate (HDI).

In a preferred embodiment the average cell-size of the core-layer A of the particle foam molding, determined by image analysis based on scanning electron microscopy of at least 100 cells of a cross-sectional area located in the center of the molding, is in the range from 60 μm to 800 μm.

In a preferred embodiment the average cell-size of the cover-layer B of the particle foam molding is in the range from 10 μm to 100 μm.

In a preferred embodiment the density of the cover-layer B of the particle foam molding, determined by image analysis based on scanning electron microscopy of at least 100 cells of a cross-sectional area located in 1 mm distance from the outer molding-skin, is in the range from 150 to 350 g/l.

In a preferred embodiment the density of the core-layer A of the particle foam molding is in the range from 80 to 200 g/l.

In a preferred embodiment the particle foam molding consists of expanded thermoplastic polyurethane beads.

In a preferred embodiment the dielectric loss factor of the expanded thermoplastic polyurethane beads of the particle foam molding measured according to DIN EN IEC 62631-2-2:2022 at 27 MHz and 20° C. is in the range from 0.06 to 0.15.

In a preferred embodiment the thermoplastic polyurethane is obtainable or obtained by reacting at least components (i) to (ii):
(i) a polyisocyanate composition (IC)
(ii) a polyol composition (PC),
wherein the polyisocyanate composition (IC) comprises at least one aliphatic diisocyanate having a number-average molecular weight of less than 200 g/mol.

In a preferred embodiment the thickness of the particle foam molding according to the invention is in the range from 0.1 to 7 cm.

In a preferred embodiment the density of the particle foam molding is in the range from 90 to 180 g/I and the compression stress at 10% compression of the particle foam molding measured according to DIN EN ISO 844:2021-07 is in the range from 70 to 130 kPa.

In a preferred embodiment the particle foam molding is obtainable or obtained by molding and fusing expanded foam beads are fused into a foam part by supplying energy in the form of at least partially through an electromagnetic field.

A further aspect relates to a method for the manufacturing of the particle foam molding according to the invention comprising the steps of
(i) loading the expanded thermoplastic polyurethane particles into a mold,
(ii) fusion of the expanded thermoplastic polyurethane particles by supplying energy at least partially through an electromagnetic field.

In a preferred embodiment the method of step (i) is a crack-filling method.

In a preferred embodiment in step (ii) the frequency of the electromagnetic field is in the range from 1 MHz to 100 MHz.

A further aspect of the invention relates to the use of the particle foam molding according to the invention in shoe soles, part of shoe soles, shoe intermediate soles, shoe insoles, damping elements, cushioning elements, underlays, grips, flooring, mattresses, sporting goods, bicycle saddles, tires and in automotive interiors and exteriors.

### BRIEF DESCRIPTION OF THE FIGURES

FIG. 1 Position of cross-section and sampling position for thin cut

FIG. 2 Position of sampling points for cell-size analysis

FIG. 3 Light microscopy image of a thin cut of the cross-section out of the particle foam molding according to example 4

FIG. 4a Light microscopy image of a thin cut of the cross-section out of a particle foam molding corresponding to comparative example 5

FIG. 4b Light microscopy image of a thin cut of the cross-section out of a particle foam molding corresponding to comparative example 6

FIG. 5a Digital photograph of the molded plate according to comparative example 1

FIG. 5b Digital photograph of the molded plate according to comparative example 2

FIG. 5c Digital photograph of the molded plate according to comparative example 3

FIG. 5d Digital photograph of the molded plate according to comparative example 4

FIG. 5e Digital photograph of the molded plate according to example 1

FIG. 5f Digital photograph of the molded plate according to example 2

FIG. 5g Digital photograph of the molded plate according to comparative example 5

FIG. 5h Digital photograph of the molded plate according to comparative example 6

FIG. 6 Digital photograph of the cross-section of a molded plate according to comparative example 7

FIG. 7 scanning electron microscope (SEM) picture showing the foam-morphology of the transition from cover-layer B to core-layer A of example 4

FIG. 8 scanning electron microscope (SEM) picture showing the foam-morphology of the core-layer A of example 4

FIG. 9 scanning electron microscope (SEM) picture showing the foam-morphology of the cover-layer B of example 4

### DETAILED DESCRIPTION OF THE INVENTION

With regards to the invention, the following can be stated specifically: According to the present invention, the object is solved by a particle foam molding comprising a core-layer A and a cover layer B both layers comprising expanded thermoplastic polyurethane beads; wherein the thermoplastic polyurethane is obtainable or obtained by reacting at least components (i) to (ii):
(iii) a polyisocyanate composition (IC) comprising at least one aliphatic diisocyanate having a number-average molecular weight of less than 200 g/mol
(iv) a polyol composition (PC) and,
   wherein the ratio of the average cell size of the cover-layer B, determined by image analysis based on scanning electron microscopy of at least 100 cells of a cross-sectional area located in 1 mm distance from the outer molding-skin, to the average cell size of the core-layer A, determined by image analysis based on scanning electron microscopy of at least 100 cells of a cross-sectional area located in the center of the molding, is in the range from 1:2 to 1:20.

Surprisingly, it was found that in contrast to moldings with a uniform cell-size distribution a particle foam molding according to the present invention combines low density with sufficient compression stress. Furthermore, in spite of the low density, the surface appearance is excellent, and edges and corners of the molding are entirely shaped. Hence, variations of mechanical properties are low.

Expanded thermoplastic polyurethane beads according to the present invention belong to the group of particle foams, which are also referred to as foamed pellets (or bead foams, particle foam, expanded thermoplastic elastomer particles or expanded thermoplastic polyurethane beads). Particle foams and moldings (also referred to as molded article) made therefrom, based on thermoplastic polyurethanes or other thermoplastic elastomers, are known (for example WO 94/20568A1, WO 2007/082838 A1, WO2017/030835 A1, WO 2013/153190 A1, WO 2010/010010 A1) and can be used in many ways.

A foamed pellet or also a particle foam or bead foam in the sense of the present invention refers to a foam in the form of a particle, the average length of the particles preferably being in the range of 1 to 10 mm. In the case of non-spherical, e.g., oval particles average length means the longest dimension by length. (determined by 3D evaluation of the granules, for example by means of dynamic image analysis with an optical measuring device named “PartAn 3D”, Microtrac).

The single foam granules according to the present invention preferably have an average mass in the range of 0.1 to 50 mg, preferable in the range between 0.5 and 45 mg. The average mass means in this context the arithmetic mean based on a sample size of 10 different particles wherein each particle is weighted three times.

The foamed pellets according to the invention usually have a bulk density of 50 g/I to 250 g/l, preferably 55 g/I to 200 g/l, more preferably 70 g/I to 180 g/l. The bulk density is measured analogously to DIN ISO 60:1999, wherein the determination of the above values in contrast to the standard, a vessel with 10 I volume is used instead of a vessel with 0.1 I volume, since especially for the foam particles with low density and large mass a measurement with only 0.1 I volume is too inaccurate.

The particle foam according to the present invention can optionally be optimized by additives such as for example dyes, process aids, nucleating agents or stabilizers. The additives may be added during the generation of the precursor of the particle foam or during the foaming step. A precursor is a polymer composition that is used as input material for foaming.

In another embodiment of the present invention, the particle foams can be coated.

In a preferred embodiment for the particle foam molding according to the invention expanded thermoplastic polyurethane beads of the same composition and the same average mass are used.

In a preferred embodiment the particle foam molding consists of expanded thermoplastic polyurethane beads.

In a preferred embodiment the dielectric loss factor of the expanded thermoplastic polyurethane beads of the particle foam molding measured according to DIN EN IEC 62631-2-2:2022 at 27 MHz and 20° C. is in the range from 0.06 to 0.15.

The dielectric properties define the interaction of the RF field with the material. Higher losses will lead to a higher increase in temperature and thereby directly influence the molding performance. The dielectric characteristics are described by the real and imaginary part of the relative permittivity εᵣ=ε′ᵣ−jε″ᵣ. The real part corresponds to the ability of the material to store the energy of the electric field, whereas the imaginary part corresponds to the dielectric losses. The so called loss factor tan(δ) is defined as the ratio of the imaginary and real part of permittivity (ε″ᵣ/ε′ᵣ). The practical meaning becomes clear when comparing an ideal and real capacitor. For an ideal capacitor, the current and voltage will have a phase delay of 90°. This phase delay is smaller than 90° by the loss angle 5.

It is assumed that the dielectric loss factor of TPU equals the dielectric loss factor of foamed TPU. There are multiple ways to measure the dielectric properties of a material. The methodological choice depends on the required frequency, the sample geometry and expected dielectric parameters. For solid dielectrics measurement guidelines are described in DIN EN IEC 62631-2-2:2022. Unless otherwise noted, for the values stated in the present invention, measurements were performed with an impedance analyzer (Keysight E4991 B) and a dedicated sample test fixture (16453A) that allows dielectric evaluation from 1 MHz-1 GHz in a temperature range from −55° C. to +150° C. The test fixture was placed in a laboratory oven to perform the dielectric characterization in the temperature range that is expected to occur during the molding process. Prior to the measurement the system was calibrated using an open, short, load (with PTFE) compensation.

Particle foam moldings (also referred to as particle foam articles or particle foam parts) are obtained or obtainable by, basically, all suitable methods for fusing the foamed beads such as compression molding with either directly or indirectly heated molds.

A preferred method for the preparation of a foam molding part includes the following steps
(A) Inserting the foamed granules according to the invention in a corresponding mold,
(B) Fusing the foamed granules according to the invention from step (A).

The fusion in step (B) preferably takes place in a closed mold, wherein the fusion can be induced by steam, hot air or energetic radiation (microwaves, radio waves or infrared waves).

The temperature at the fusion of the foamed granules is preferably below or close to the melting temperature of the polymer from which the particle foam was produced. For the common polymers, therefore, the temperature for fusion of the foamed granules is between 80° C. and 180° C., preferably between 100° C. and 150° C.

Temperature profiles/residence times can be determined specifically for the used materials, e.g., in analogy to the methods described in US20150337102 or EP2872309.

Generally, the cover-layer B can cover the core-layer completely or partially.

In a preferred embodiment the cover-layer B is surrounding the core-layer A on all sides as illustrated in FIG. 2.

In another embodiment the cover-layer B covers the core-layer A on two opposite planes.

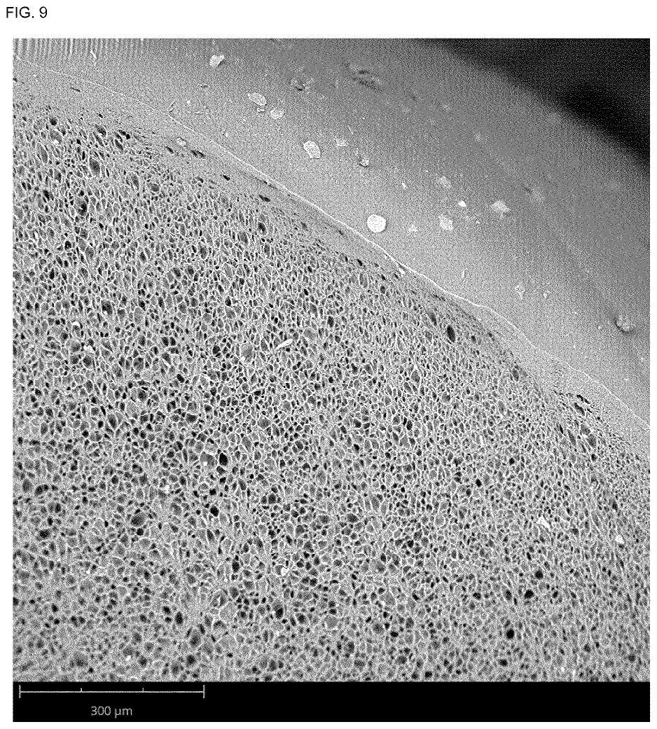

The cover-layer B can have a sealed surface (FIG. 9) or a surface with an open cell-structure.

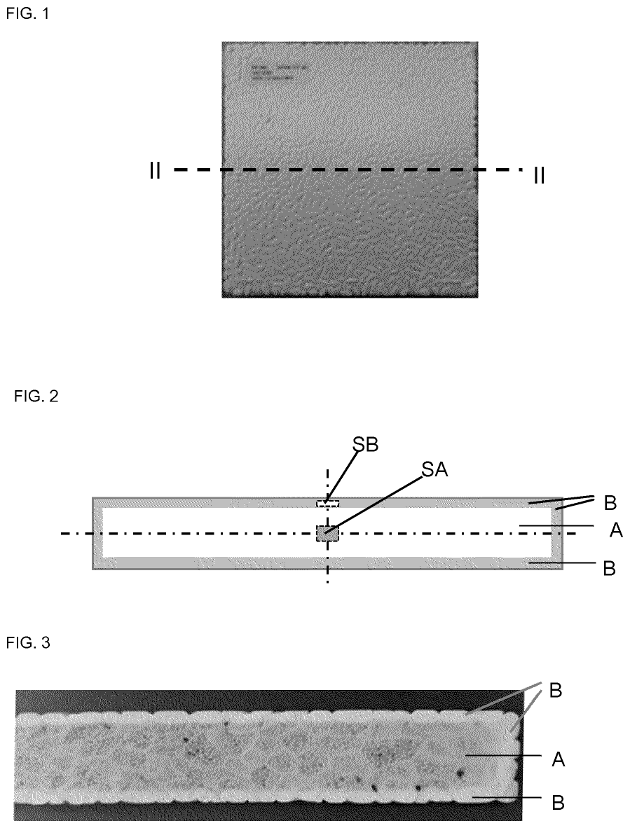

The average cell size of the cover-layer measured at sample point SB (FIG. 2) of a central cross-section (FIG. 1) in 1 mm distance of the outer is preferably in the range from 10 μm to 100 μm. More preferably, the average cell-size of the cover layer B is in the range from 10 μm to 60 μm.

The core-layer A is characterized by a coarser cell-structure compared to the cover layer. The average cell size of the core-layer measured at sample point SA (FIG. 2) of a central cross-section (FIG. 1) is preferably in the range from 60 μm to 800 μm. More preferably the average cell size of core-layer A is in the range from 200 μm to 500 μm.

The ratio between the average cell size of the cover-layer and the average cell size of the core-layer is in the range from 1:2 to 1:20. In a preferred embodiment the ratio between the average cell size of the cover-layer and the average cell size of the core-layer is in the range from 1:2 to 1:10.

The average cell size was measured using a SEM (scanning electron microscope) picture combined with an image analysis software based on Image J. The software measures the area of the cells within the SEM picture. Afterwards the determined cell-area is converted in a notional circle with the same area and the diameter of the circle taken as the diameter of the cell. To calculate the average cell diameter, the procedure is applied for at least 100 different cells and the average value is calculated.

Generally, the transition from the cover to the core-layer can appear in form of a transition zone characterized by a gradually increasing cell-size toward the core-layer or in form of a distinct and significant change of the average cell-size.

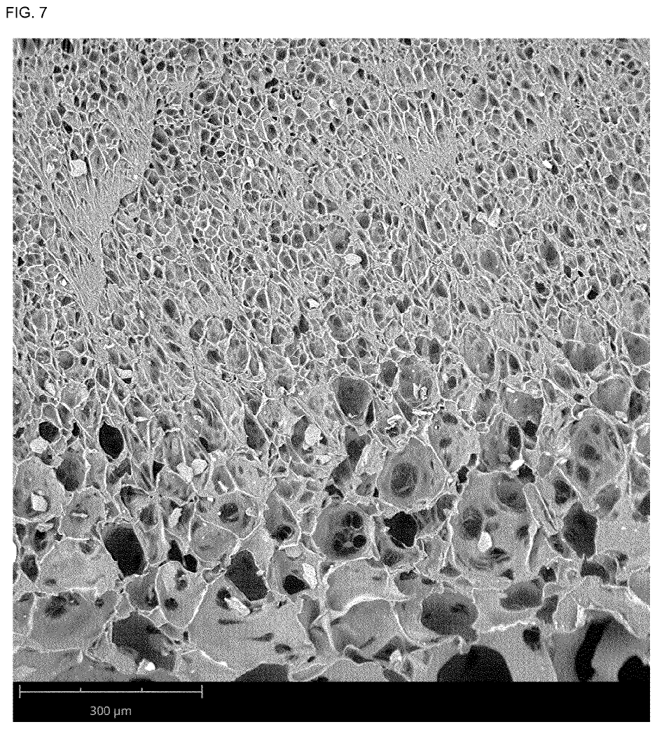

Preferably the transition from the cover to the core-layer appears in form of a transition zone characterized by a gradually increasing cell-size toward the core-layer (FIG. 7).

In one embodiment according to the present invention core-layer A and cover-layer B comprise different expanded thermoplastic polyurethane beads. The difference can be for example in bead size, cellular morphology or composition.

In a preferred embodiment cover-layer B and core-layer A comprise the same foam-bead material regarding bead size and chemical composition.

In one embodiment according to the present invention the density of the core-layer is lower than the density of the cover-layer.

In a further embodiment the particle foam molding can be coated or laminated.

In general, the particle-foam molding according to the invention can have all kind of shapes such as sheets, flat sheets, three-dimensional articles with varying thicknesses, cones, cylinders or any other kind of shape.

In a preferred embodiment according to the present invention the average thickness of the particle foam molding is in the range from 0.1 to 7 cm.

The moldings can be produced by means of molding machines. For this purpose, the foamed particles are conveyed into the shaping tool manually or automated by using pressurized air.

The shaping tool also referred to as mold or molding tool comprises two primary components, the injection mold-plate with the filling nozzles, and a counterpart-plate. To generate the molding part, both mold-plates are pressed together so that a cavity in the shape of the molding part is formed. The filling of the mold-cavity can be conducted either by crack filling method or by the pressure filling method.

The crack-filling method comprises the following steps:
(i) injecting the expanded foam-particles into the mold-cavity without a backpressure of the counterpart-plate,
(ii) fusing the particles while closing the plates of the mold mechanically,
(iii) cool down the molding part and
(iv) demold the produced part,
wherein in step (i) a gap between the injection mold-plate and the counterpart-plate is adjusted which is also referred to as crack-height. The mold-cavity is filled with a predetermined amount of the expanded beads in step (i). In step (ii) the volume of the mold-cavity is reduced compared to step (i), because the two parts of the molding tool are closed tightly and the intermediate gap is, thus, disappeared. This leads to a pressure increase within the mold-cavity. The expanded beads are thus pressed against one another and can therefore become fused to give the molding.

The degree of compression is one important parameter to control the fusion-quality of the molding. The degree of compression is calculated by dividing the dosage volume per cycle through the volume of the mold cavity adjusted in step (ii), wherein the dosage volume per cycle is given by the dosage weight per cycle divided through the bulk density of the foamed beads.

In one embodiment according to the present invention the degree of compression is in the range from 1.7 to 2.3. Preferably, the degree of compression at the crack-filling method is lower than 2.

The pressure filling method comprises the following steps:
(i) injecting the expanded foam-particles into the mold-cavity by pneumatic pressure while compressing both plates of the mold tightly together,
(ii) fusing the particles,
(iii) cool down the molding part,
(iv) demold the produced part.

Since the exerted injection pressure in step (i) is ceased in step (ii) the inserted foam beads may further expand and as a result be pressed against one and another and, therefore, become fused and give the molding.

The fusing in step (ii) can be induced by means of steam or by means of at least one electromagnetic field, independently of the chosen loading method.

In case of using steam to induce the fusing, three different steaming-methods can be used in the molding machine to fuse the foamed particles: crack steaming (only when applying the crack-filling method), cross-steaming and autoclave steaming. Cross steaming strongly supports the bonding between the particles inside the molding part. The steam flows through the filled mold cavity from one side of the mold to the other side first and then the flow is changed into the opposite direction. In contrast, in case of autoclave steaming the steam comes from both sides of the molding tool at the same time.

The energy may be supplied by electromagnetic induction. For this purpose, a dielectric molding-tool is placed in between at least two capacitor plates which generate at least one dielectric field. The expanded foam beads are loaded into the cavity of the molding tool and are heated by applying the dielectric field. As a result, the surface of the foam beads is partially molten and, therefore the beads become fused and form the molded part. To preserve the foam morphology and melt the bead surface only, the process is adapted in accordance with the used materials and the design of the molded article. In general, the energy input is controlled and adjusted by the applied voltage, the irradiation time, and the amount of material. Before the molded part can be removed from the molding tool, it must be stabilized and cooled down. The stabilization can be achieved by stopping the active heating or by means of an active cooling-procedure, such as for example described in EP3405322.

Fusing by energetic radiation is generally carried out in the microwave-frequency range of 300 MHz-300 GHz or in the radio-frequency range of 30 kHz-300 MHz. Microwaves are preferably applied in the frequency range between 0.5 and 100 GHz, especially preferably in the range between 0,8 and 10 GHz and irradiation times between 0.1 and 15 min are used. Radio waves are preferably applied in the frequency range between 500 kHz and 100 MHz, especially preferably in the range between 1 MHz and 80 MHz and irradiation times between 0.1 and 30 min are used.

The invention is explained using the following examples without being restricted thereto.

### EXAMPLES

Generation of thermoplastic polyurethane (TPU) as precursor for expanded thermoplastic polyurethane particles (eTPU) TPU which serves as precursor for the was produced by means of a twin-screw extruder ZSK 58MC with a length of 48 D of the company Coperion. After the twin screw extruder, a melt pump, a melt filter, and an underwater cutting system were arranged within the mentioned sequence. The melt was cut into single compact particles of 40 mg using the underwater pelletizing system and the particles dried at 40-90° C. using a heated fluidized bed.

The polyol, the isocyanate as well as the chain extender were added in the first barrel section of the twin screw extruder, further additives followed in barrel section 8 out of 12. The used TPU recipe is shown in Table 1.

The barrel temperature was set to 180-230° C. while the resulting melt temperature was in the range of 210-230° C. at a screw speed of 180 to 240 rpm. The overall throughput during the TPU production was 200 kg/h.

TABLE 1

| | TPU 1 |
|---|---|
| PTHF1000, Functionality 2 | 100.00 parts |
| 1,6-HDI | 35.25 parts |
| 4,4′-MDI | |
| 1,4-Butanediol | 10.19 parts |
| Hindered phenol antioxidante | 0.74 parts |
| Light stabilizer | 0.74 parts |
| Talcum | 0.22 parts |
| Ethylene-bis-stearamide | |

### Measuring Dielectric Properties

Sample plates of the generated TPU precursors were analyzed with regard to their dielectric properties applying the measurement guidelines are described in DIN EN IEC 62631-2-2:2022. It is assumed that the dielectric loss factor of TPU equals the dielectric loss factor of foamed TPU. The measurements were performed with an impedance analyzer (Keysight E4991 B) and a dedicated sample test fixture (16453A) that allows dielectric evaluation from 1 MHz-1 GHz in a temperature range from −55° C. to +150° C. The test fixture was placed in a laboratory oven to perform the dielectric characterization in the temperature range that is expected to occur during the molding process. Prior to the measurement the system was calibrated using an open, short, load (with PTFE) compensation. Table 2 shows the dielectric loss factor also referred to as tan(δ) of TPU1 for two different conditions.

TABLE 2

| Frequency | Temperature | tan(δ) of TPU1 |
|---|---|---|
| 1 MHz | 20 | 0.0418 |
| 27 MHz | 20 | 0.101 |

### Foaming of TPU 1

TPU 1 was foamed according to WO2007/082838 using a stirred, heated, and pressurized vessel. For this purpose, 100 parts of TPU 1, 217 parts of water based on the amount of TPU 1 and 36 parts of blowing agent n-butane based on the amount of TPU 1 were added into the pressure vessel. The mixture was heated up to 109° C. while steering constantly. After reaching 109° C., the temperature was kept constant for 60 min to enable a full impregnation of the compact beads with the blowing agent. Afterwards, the impregnated TPU beads with water and the remaining blowing agent were let out of the vessel by opening a valve at the bottom of the vessel. To avoid a sudden pressure drop within the vessel and to hold a constant high pressure level, the vessel was pressure loaded with nitrogen from the top of the vessel.

The impregnated particles expanded due to the pressure drop while entering the vessel through the bottom valve and, afterwards, were dried at about 50° C. in a heated fluidized bed.

The expanded beads (eTPU 1) obtained via the above method show a fine cell structure characterized by average cell size in the range of 10-40 μm and a bulk density of 83 g/l.

The average cell size was measured using a SEM (scanning electron microscope) picture combined with an image analysis software based on Image J. The software measures the area of the cells within the SEM picture. Afterwards the determined cell-area is converted in a notional circle with the same area and the diameter of the circle taken as the diameter of the cell. To calculate the average cell diameter, the procedure is applied for at least 100 different cells and the average value is calculated.

The bulk density was measured according to DIN EN ISO 60:1999. In difference to the standard, a bucket with a volume of 10 I was measured instead of 100 ml. The funnel was placed above the bucket in a distance of 100 mm from the lower end of the funnel to the upper end of the bucket. The funnel had an inner diameter of 300 mm on the top and 50 mm on the bottom where the expanded beads escape to fall into the bucket.

Molding of eTPU 1

eTPU 1 was molded using the Wave Foamer C from company Kurtz at a frequency of 27.14 MHz of the electromagnetic field (radio frequency molding). The mold was prepared out of polyethyleneterephtalate with a length and width of 200 mm each and a variable height that can be set to 10 and 20 mm.

For molding, the cavity was opened, and the required amount of material was homogeneously placed manually into one half of the open mold. Afterwards, the mold was closed to a height of 20 mm and the molding process started. The used amount of eTPU 1 as well as the corresponding degree of compaction and the used molding conditions are shown in Table 3. The degree of compaction corresponds out of the volume of the eTPU placed into the mold (amount in grams divided by the bulk density in g/l) and the final volume within the mold after closing of 200×200×20 mm³ (Volume of 0.8 I).

TABLE 3

| Example/ | | | | | | |
|---|---|---|---|---|---|---|
| comparison | | Amount of | Degree of | Final part | Molding | |
| example | Material | eTPU | compaction | density | time | Voltage |
| Comparative | eTPU 1 | 126 g | 1.9 | 158 g/l | 35 s | 5.5 kV |
| Example 1 | | | | | | |
| Comparative | eTPU 1 | 126 g | 1.9 | 158 g/l | 40 s | 6.0 kV |
| Example 2 | | | | | | |
| Comparative | eTPU 1 | 126 g | 1.9 | 158 g/l | 40 s | 6.5 kV |
| Example 3 | | | | | | |
| Comparative | eTPU 1 | 146 g | 2.2 | 183 g/l | 40 s | 6.5 kV |
| Example 4 | | | | | | |
| Example 1 | eTPU 1 | 126 g | 1.9 | 158 g/l | 40 s | 6.8 kV |
| Example 2 | eTPU 1 | 126 g | 1.9 | 158 g/l | 50 s | 6.8 kV |
| Example 3 | eTPU 1 | 126 g | 1.9 | 158 g/l | 60 s | 6.8 kV |
| Example 4 | eTPU 1 | 126 g | 1.9 | 158 g/l | 70 s | 6.8 kV |

Further comparison examples using standard molding method with steam are shown in Table 4. eTPU1 was molded by means of standard molding technique with steam. For this purpose, the steam molding machine “Energy Foamer” by company Kurtz Ersa with a mold cavity of the same dimensions as being used for the examples shown in Table 3 was used. During filling the mold was opened to a distance of 40 mm and afterwards closed to 20 mm. The respective molding parameters are shown in Table 4. To compare with the radio frequency molding also for the steam molding two different conditions with standard (comparison example 5) and higher (comparison example 6) steam energy were used

TABLE 4

| | | | Cross | | | |
|---|---|---|---|---|---|---|
| | | | Steaming | Cross | Cross | Cross |
| | | Cross | MII | Steaming | Steaming | Steaming |
| Comparision | | steaming | pressure | MII time | MI pressure | MI time |
| Example | Material | Start | [bar] | [s] | [bar] | [s] |
| Comparative | eTPU 1 | MII | 0.6 | 40 | 0.6 | 40 |
| Example 5 | | | | | | |
| Comparative | eTPU 1 | MII | 1.1 | 25 | 1.2 | 20 |
| Example 6 | | | | | | |
| Comparative | eTPU 1 | MI | 0.8 | 25 | 0.8 | 20 |
| Example 7 | | | | | | |
| | | Autoclave | Autoclave | | | |
| | | MI | MII | Autoclave | Cooling | Final Part |
| Comparision | | Pressure | Pressure | time | time | Density |
| Example | Material | [bar] | [bar] | [s] | [s] | [g/l] |
| Comparative | eTPU 1 | 1.0 | 1.0 | 60 | 120 | 171 |
| Example 5 | | | | | | |
| Comparative | eTPU 1 | 1.2 | 1.3 | 15 | 80 | 191 |
| Example 6 | | | | | | |
| Comparative | eTPU 1 | 0.8 | 0.85 | 15 | 110 | 159 |
| Example 7 | | | | | | |

### Properties of the Moldings

The prepared molded plates were optically characterized regarding their quality. In particular, the molding-quality was assessed based on the surface structure, the appearance of not-entirely filled edges and corners as well as the appearance of gaps between single beads also referred to as gussets. Furthermore, the part density, the resulting foam structure and the mechanical properties were analyzed.

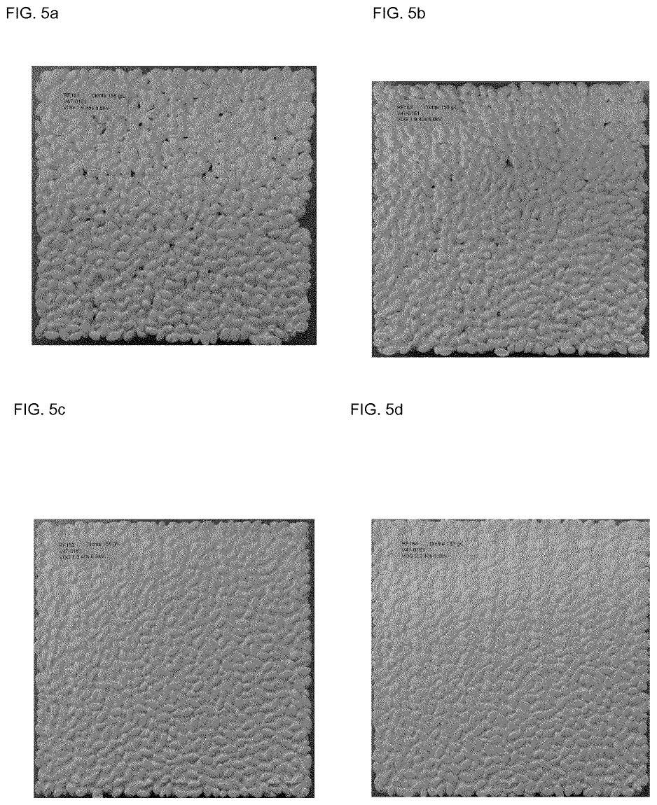

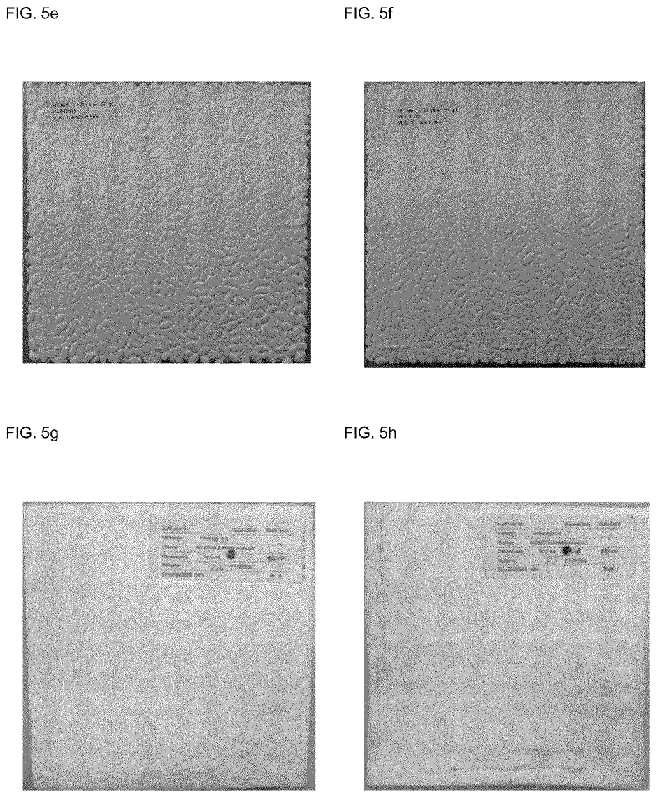

The photographs of the full plates shown in FIG. 5a-h were taken with a standard digital camera. To prepare the larger cross-sections, the molded plate was first cut into two pieces along a cutting line according to FIG. 1 using a band saw, afterwards immersed into dry ice to preserve the cell structure, and then, the frozen part was cut again with a circular saw into thin slices. The pictures of the thin slices also referred to as thin cuts were made with a light microscope. The density of the molding was measured by dividing the weight of a sample piece measured on a balance with an accuracy of 0.1 g by the volume of the sample piece obtainable by measuring the sample dimensions by taking the width, length and height using a digital measuring slide.

FIGS. 5a to 5h show digital photographs of the molded plates according to the examples and comparative examples listed in Table 3 and Table 4. Comparative examples 1, 2, 3 and 4 were generated by means of radio frequency molding at 27 MHz with a voltage of 5.5 kV, 6.0 kV, 6.5 kV and 6.5 kV. For comparative examples 1, 2 and 3 a degree of compaction of 1.9 was adjusted and, for comparative example 4 the degree of compaction was increased to 2.2 according to the state of the art in order to obtain a fully filled molding plate (Table 3). As shown in FIGS. 5a to 5c, a stepwise increase of voltage and, thus, an increase of energy input induced by radio-frequency radiation leads to an increase of fusion quality. The very low voltage applied in comparative example 1 is linked with a not fully filled plate with gaps in between the beads and holes distributed throughout the whole plate (FIG. 5a). In case of an increase of voltage to 6.5 kV according to comparative example 3 the holes throughout the molding plate are disappeared. However, still single beads in the side walls and in the surface are visible (FIG. 5c). Although comparative examples 1, 2 and 3 are characterized by a low density of 158 g/I a sufficient fusion of the foamed beads could not be reached. If, according to the state of the art, the filling of the mold cavity and with this the fusion quality is improved by increasing the loading volume and the degree of compression, the density of the generated molding is raised as well and still single beads with no smooth surface appear (Table 3, FIG. 5d). In contrast, the inventive examples 1 and 2 combine a smooth surface with all beads fused within the molding plate (FIG. 5e, f) and a low molding density (Table 3). FIG. 5g and FIG. 5h show digital photographs of steam chest molded plates according to comparative example 5 and 6 (Table 3). Complete filling of the mold cavity and with this a smooth surface with all beads fused within the plate was only achievable by increasing the material load and, therefore is combined with a higher molding density compared to the inventive examples. If the energy input is increased by basically increasing the steam pressure during the fusing step (Table 4), the beads start to melt and the bead structure on the surface disappears (FIG. 5h). Furthermore, the molding density is increased significantly due to the start of foam-bead melting.

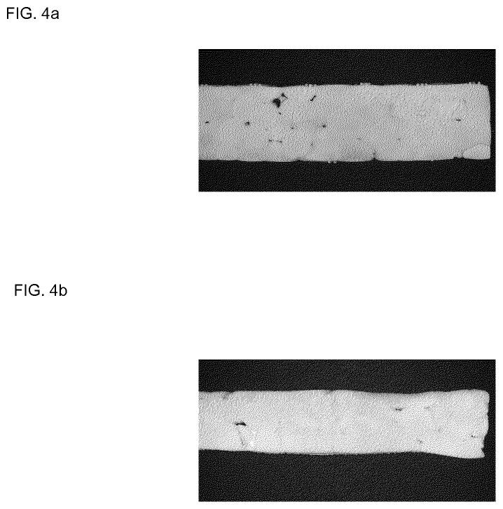

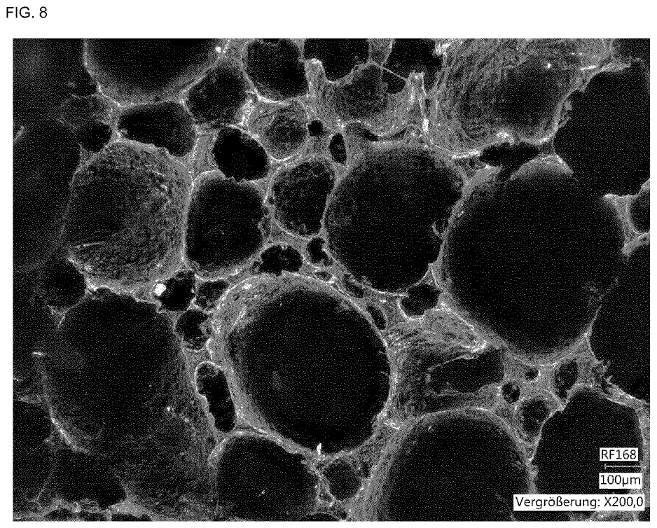

FIG. 3 shows a part of a thin cut of the cross-section out of a particle foam molding according to example 4. Cover-layer and core-layer are clearly visible. The cover-layer is surrounding the core-layer and appears more compact compared to the core-layer. Even at the low magnification of the light microscope the cellular structure of the core can be recognized. However, scanning electron microscope (SEM) picture of the cover-layer reveals a fine, mainly closed cellular structure (FIG. 9). The SEM of the core layer A of example 4 reveals the coarse cellular structure (FIG. 8). In contrast, the above-described structure of cover- and core-layer does not appear in case of the comparative examples (FIGS. 4a and b). Pictures of thin slices of moldings obtained by steam chest molding according to Table 4 (comparative examples 5, 6, 7) reveal the typical morphology homogeneously fused foam beads (FIG. 4a) and no cover and core layer can be recognized. In case of comparative example 6, the start of melting of the foam beads can be recognized by a reduced thickness compared to comparative example 5 and 7.

The density of the cover layer B and the core layer A were measured by cutting samples of 25 mm in length and width with the full heights of 20 mm out of the middle part of a plate. Afterwards, the cover layer was cut off on both sides using a razor blade. Here, the corresponding cover layers were in the range of 2-4 mm in heights. For both cover layers as well as the core layer, the part density was measured using the Archimedes principle with a balance from Mettler Toledo (accuracy of 0.0001 g) and the density kit including a water bath for distilled water, a temperature sensor for the water and a device to measure the weight of the sample at air and immersed into the water. Due to the low density of the samples, the device hindering the sample to float on the water was used. The density of the sample can be calculated as also given within the document to use the density kit by dividing the mass of the sample weight in air by the weight in air minus the weight immersed into the liquid. Finally, the result has to be multiplied by the density of the water, the sample was weight inside, which can be determined by the water temperature out of literature. The measurement was conducted at least at three samples separating both cover layers and the core layer. That means at least 6 cover layer pieces and 3 core layer pieces. Out of the measurements, the average value was calculated for the cover layer and the core layer respectively. The results measuring the density according to the description for Example 2 is shown in Table 5.

TABLE 5

| Example 2 | Average density [g/l] |
|---|---|
| Core layer | 157.9 ± 3.5 |
| Cover layer | 258.8 ± 13.0 |

The foam structure was analyzed as described above for the expanded eTPU 1 beads. The Average cell size for the cover layer B and the core layer A of Example 2 is given in Table 6. In case of Example 2 the ratio of the average cell size of the cover-layer B to the average cell size of the core-layer A is approximately 1:10.

TABLE 6

| Example 2 | Average cell diameter [μm] |
|---|---|
| Core layer A | 293 μm |
| Cover layer B | 31 μm |

Finally, the compression properties of Example 2 and Comparison Example 3, 5 and 7 were measured according to DIN EN ISO 844:2021-07 using a sample height of 20 mm and a test speed of 100 mm/min. Before the measurement starts, the machine compresses the sample until 1 N is reached and the corresponding heights is taken as the upper surface of the sample. The measurement is repeated 5 times and the average value is calculated. The results of the compression stress reached at 10% compression are listed in Table 7. The inventive Example 2 which is characterized by a final part density of 158 g/I shows a compression stress at 10% compression of 111 kPa whereas comparative example 7 which is characterized by a similar final part density of 159 g/I achieves a compression stress at 10% of 49 kPa only. The achievable compression stress of molded parts obtained via steam-chest molding can only be increased by increasing the part-density (see Table 7, comparative Examples 3, 5).

TABLE 7

| | Compression stress at 10% | |
|---|---|---|
| Sample | compression | |
| Example 2 | 111 ± 5 | kPa |
| Comparative Example 3 | 78 ± 20 | kPa |
| Comparative Example 5 | 85 ± 7 | kPa |
| Comparative Example 7 | 49 ± 7 | kPa |

### Foaming and Molding of TPA

In addition to TPU a commercially available TPA (Pebax 4033, Arkema) was foamed according to WO2017/220671 Example 11 achieving a bulk density of about 85 g/I (eTPA 1). Afterwards, the material was molded as described above using the Wave Foamer C from company Kurtz. The molding parameter are summarized in Table 8.

TABLE 8

| Example/ | | | | | | |
|---|---|---|---|---|---|---|
| comparison | | Amount of | Degree of | Final part | Molding | |
| example | Material | eTPA | compaction | density | time | Voltage |
| Comparision | eTPA 1 | 129 g | 1.9 | n.a. | 30 s | 7 kV |
| Example 8 | | | | | | |

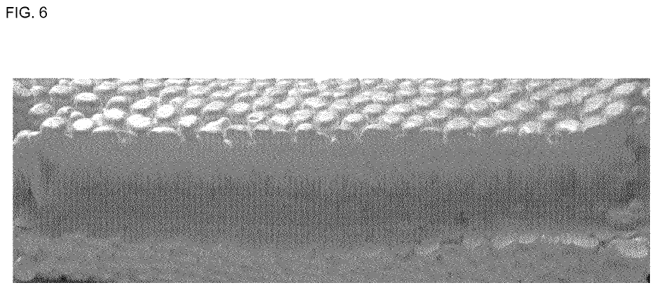

After molding, the part was taken out and tried to cut using a knife. Full cut of the part was not possible by hand as the inner part was already molten (FIG. 6). This is in accordance to the state of the art shown in WO2017/125410 A1 for PLA and PET.

1: A particle foam molding comprising a core-layer A and a cover layer B, both layers comprising expanded thermoplastic polyurethane beads, wherein the thermoplastic polyurethane is obtained by reacting at least components (i) to (ii):
(i) a polyisocyanate composition (IC) comprising at least one aliphatic diisocyanate having a number-average molecular weight of less than 200 g/mol; and
(ii) a polyol composition (PC);
wherein a ratio of an average cell size of the cover-layer B, determined by image analysis based on scanning electron microscopy of at least 100 cells of a cross-sectional area located at a 1 mm distance from an outer molding-skin, to an average cell size of the core-layer A, determined by image analysis based on scanning electron microscopy of at least 100 cells of a cross-sectional area located at a center of the molding, is 1:2 to 1:20.

2: A particle foam molding according to claim 1, wherein the at least one aliphatic diisocyanate is-comprises a hexamethylene diisocyanate (HDI).

3: A particle foam molding according to claim 1, wherein the average cell-size of the core-layer A is 60 μm to 800 μm.

4: A particle foam molding according to claim 1, wherein the average cell-size of the cover-layer B is 10 μm to 100 μm.

5: A particle foam molding according to claim 1, wherein a density of the cover-layer B is 150 to 350 g/l.

6: A particle foam molding according to claim 1, wherein a density of the core-layer A is 80 to 200 g/l.

7: A particle foam molding according to claim 1, wherein a thickness d1 of the core-layer A is more than ⅓ of a thickness d of the particle foam molding.

8: A particle foam molding according to claim 1 consisting of expanded thermoplastic polyurethane beads.

9: A particle foam molding according to claim 1, wherein a dielectric loss factor tan δ of the particle foam molding measured according to DIN EN IEC 62631-2-2:2022 at 27 MHz and 20° C. is 0.06 to 0.15.

10: A particle foam molding according to claim 1, wherein a thickness of the particle foam molding is 0.1 to 7 cm.

11: A particle foam molding according to claim 1, wherein a density of the particle foam molding is 90 to 180 g/l and a compression stress of the particle foam molding at 10% compression measured according to DIN EN ISO 844:2021-07 is 70 to 130 kPa.

12: A particle foam molding according to claim 1 obtained by molding and fusing expanded foam beads by supplying energy at least partially through an electromagnetic field.

13: A method for manufacturing particle foam molding according to claim 1, comprising:
(i) loading the expanded thermoplastic polyurethane particles into a mold-; and
(ii) fusing the expanded thermoplastic polyurethane particles by supplying energy at least partially through an electromagnetic field.

14: A method according to claim 13, wherein loading the expanded thermoplastic polyurethane particles comprises employing a crack-filling method.

15: The method according to claim 14, wherein a frequency of the electromagnetic field is 1 MHz to 100 MHz.

16: The particle foam molding according to claim 1, wherein the particle foam molding is in a form selected from the group consisting of a shoe sole, a part of a shoe sole, a shoe midsole, a shoe insole, a damping element, a cushioning element, an underlays, a grip, a flooring, a mattress, a sporting good, a bicycle saddle, a tire, an automotive interior component, and an automotive exterior component.
